(19) United States
(12) Patent Application Publication
(10) Pub. No.: US 2012/0230189 A1
(43) Pub. Date: Sep. 13, 2012

(54) System and method of transferring Wi-Fi clients between SSIDs

(75) Inventors: Yang Lit Fang, Singapore (SG); Kwang Wee Lee, Singapore (SG)

(73) Assignee: Medium Access Systems Private Limited

(21) Appl. No.: 13/199,451

(22) Filed: Aug. 31, 2011

Related U.S. Application Data
(63) Continuation-in-part of application No. 13/068,395, filed on May 10, 2011.
Application No. 13/068,395 is a continuation-in-part of application No. 13/043,226, filed on Mar. 8, 2011.

(51) Int. Cl. H04W 28/08

(52) U.S. Cl. 370/230

(57) ABSTRACT

A computer networking system for load balancing, which comprises: a network, computing devices, access points each with a service set identifier, and a network management device. The network management device can receive a request from a computing device to access the network via a signal associated with a first service set identifier. In response to the request, the network management device receives loading information, which includes information associated with the access points. From the loading information, the network management device determines a least loaded access point, that is, the access point0 associated with a smallest quantity of computing devices. The network management device will send a service set identifier associated with the least loaded access point to the computing device which sent the access request. This computing device may then connect to the network via the least loaded access point and via the service set identifier associated with the least loaded access point.

This application is a continuation-in-part of co-pending U.S. patent application Ser. No. 13/068,395, filed May 20, 2011, entitled “Method and System of Intelligently Load Balancing of Wi-Fi Access Point Apparatus in a WLAN,” which itself is a continuation-in-part of co-pending U.S. patent application Ser. No. 13/043,226, filed Mar. 8, 2011, entitled “Method and System for Data Offloading in Mobile Communications.” Each of these co-pending applications are hereby incorporated by reference.

### FIELD

The present disclosure relates to a method and system for load balancing in wireless computer networking.

### BACKGROUND

In most wireless computer networks, users connect to the wireless network through base stations, referred to herein as access points (“APs”), and the service set identifiers (“SSID”) of those APs. U.S. patent application Ser. No. 13/068,395 teaches a system and method for Wi-Fi load balancing, which uses a common or Beacon SSID (as defined therein) and switches Wi-Fi client from the Beacon SSID to another SSID. There is a need for other approaches for switching from one SSID to another SSID, wherein load balancing and network management occurs on an AP.

### SUMMARY

In one aspect, the present invention is a computer networking system for load balancing, which comprises: a first computing device; one or more first access points, wherein each of the one or more first access points has a service set identifier; and a network management device having at least one memory with at least one region for storing executable program code, and at least one processor for executing the program code stored in the memory. When the program code is executed, it performs the following: receives a request from the first computing device to access a network, wherein the request is received via a signal associated with a first service set identifier; receives loading information, wherein the loading information includes information associated with at least one of the one or more first access points; determines, from the loading information, a least loaded access point, wherein the least loaded access point is one of the one or more first access points that is associated with a smallest quantity of one or more second computing devices; and sends a service set identifier associated with the least loaded access point.

In another aspect, the present invention is a method for load balancing a computer networking system, which comprises the following: receiving, by a network management device, a request from a first computing device to access a network, wherein the request is received via a signal associated with a first service set identifier, and wherein the network management device having at least one memory with at least one region for storing executable program code and at least one processor for executing the program code stored in the memory; receiving, by the network management device, loading information, wherein the loading information includes information associated with at least one of one or more first access points, and wherein each of the one or more first access points has a service set identifier; determining, by the network management device, from the loading information, a least loaded access point, wherein the least loaded access point is one of the one or more first access points that is associated with a smallest quantity of one or more second computing devices; and sending, by the network management device, a service set identifier associated with the least loaded access point.

In one aspect, the present invention is a computer networking system for load balancing, which comprises: a first computing device; one or more first access points, wherein each of the one or more first access points has a service set identifier; a network management device having at least one memory with at least one region for storing executable program code, and at least one processor for executing the program code stored in the memory. When the program code is executed, it performs the following: receives a request from the first computing device to access a network, wherein the request is received via a signal associated with a first service set identifier; receives loading information, wherein the loading information includes information associated with at least one of the one or more first access points; generates, from the information received, a list comprising at least one of the one or more first access points able to support a connection with the first computing device; and sends the list to the first computing device.

In another aspect, the present invention is a method for load balancing a computer networking system, which comprises the following: receiving, by a network management device, a request from a first computing device to access a network, wherein the request is received via a signal associated with a first service set identifier, and wherein the network management device having at least one memory with at least one region for storing executable program code and at least one processor for executing the program code stored in the memory; receiving, by the network management device, loading information, wherein the loading information includes information associated with at least one of the one or more first access points, and wherein each of the one or more first access points has a service set identifier; generating, by the network management device, from the information received, a list comprising at least one of the one or more first access points able to support a connection with the first computing device; and sending, by the network management device, the list to the first computing device.

In one aspect, the present invention is a computer networking system, which comprises: at least one memory having at least one region for storing executable program code; at least one processor for executing the program code stored in the memory; means for receiving a request from a first computing device to access a network, wherein the request is received via a signal associated with a first service set identifier; means for receiving loading information, wherein the loading information includes information associated with at least one of one or more first access points, and wherein each of the one or more first access points has a service set identifier; means for determining, from the loading information, a least loaded access point, wherein the least loaded access point is one of the one or more first access points that is associated with a smallest quantity of one or more second computing devices; and means for sending a service set identifier associated with the least loaded access point.

### BRIEF DESCRIPTION OF THE DRAWINGS

Example embodiments of the disclosure will be described by way of example only and with reference to the drawings, in which:

FIG. 1 shows a schematic diagram of one aspect of the present invention for load balancing in a wireless network communication infrastructure;

FIG. 2 shows a flow diagram of a method of load balancing in a wireless network communication infrastructure according to one aspect of the present invention;

FIG. 3 shows a schematic diagram of another aspect of the present invention for load balancing in a wireless network communication infrastructure;

FIG. 4 shows a schematic diagram of yet another aspect of the present invention for load balancing in a wireless network communication infrastructure;

FIG. 5 shows the data flow during the load balancing protocol sequence in accordance one aspect of the present invention;

The drawings are exemplary, not limiting. Items that are labelled with the same reference number in multiple figures refer to the same item throughout the figures.

### DETAILED DESCRIPTION

The objective for using a common service set identifier (“SSID”) or Beacon SSID is to identify the presence of certain Wi-Fi service providers, and switching a client from the Beacon SSID and another SSID on the same or different AP. Load balancing of the wireless network in the same coverage area is achieved by distributing client or bandwidth loading depending on overall or individual loading of APs. This distributing is performed by switching or “swinging” Wi-Fi clients from the Beacon SSID to another SSID of a different or the same AP via a daemon program or system application on the Wi-Fi client system. As used herein, “SSID” refers to either or both a name that identifies a particular 802.11-based wireless LAN and a 802.11-based wireless LAN.

### Overview

Various embodiments of the present invention will now be described in greater detail with reference to the drawings.

In the preferred embodiment, the APs are at least Wi-Fi access points (sometimes referred to as “wireless routers”) operating in accordance with IEEE 802.11-based standards and connected to other devices or elements via wireless or wired connections.

Beacon SSID: The Beacon SSID is used by the Daemon, also known as a system application, to communicate with the Asset Access Controller (“AAC”) and as a medium for information regarding which SSID to connect or transfer in order to access the Internet. The Beacon SSID may operate according to IEEE 802.11-based standards.

In one aspect, the Beacon SSID operates on a communications port for authentication and communication with the AAC. For example, the communications port used for the Beacon SSID may be port 1812.

In another aspect, the communications port for the Beacon SSID may not be used for an Internet connection. Here, access to port 80 (http), port 8080 (alternate http), port 21 (ftp) and other communications ports may be blocked or limited.

In yet another aspect, the Beacon SSID may be open (i.e., without Wi-Fi encryption); or encrypted using Wired Equivalent Privacy (WEP) or Wi-Fi Protected Access (WPA), or employ other forms of wireless networking security.

Client Personal Equipment and Daemon: Client Personal Equipment (“CPE”), also known as a Wi-Fi client, may be a cellular phone, smart phone, tablet, portable computer, desktop computer, laptop computer, game console, personal media player, handheld computing device, portable gaming device, or similar devices, and is not limited to microprocessor-based devices.

The Daemon is installed, loaded, residing, or running on a CPE. When a CPE attempts to access the Internet, the Daemon scans for a Beacon SSID. The Daemon will then authenticate with the AAC via the Beacon SSID. The Daemon's authentication with AAC may use or be based on the authentication protocols associated with the IEEE 802.11 standard (e.g., WPA based protocols, WEP protocols, hardware security token, central radius server etc.). The Daemon will then receive an SSID from the AAC which may be different from the Beacon SSID. The Daemon may also receive an access password for establishing an Internet connection via that different SSID. The Daemon will instruct, operate, or direct the Wi-Fi device, application or driver on the CPE to establish a connection to the Internet using the access password.

In one aspect, the password associated with the WEP, WPA or other wireless networking security for the Beacon SSID, if any, may be different from any password or token used in connection with the Daemon's authentication with the AAC.

In another aspect, the different SSID may be open (i.e., without Wi-Fi encryption); or encrypted using WEP or WPA, or employ other forms of wireless networking security. Where WEP, WPA or other form of security is used for the different SSID, the password associated with the WEP, WPA or other form of security, may be different from the access password for establishing a connection to the Internet.

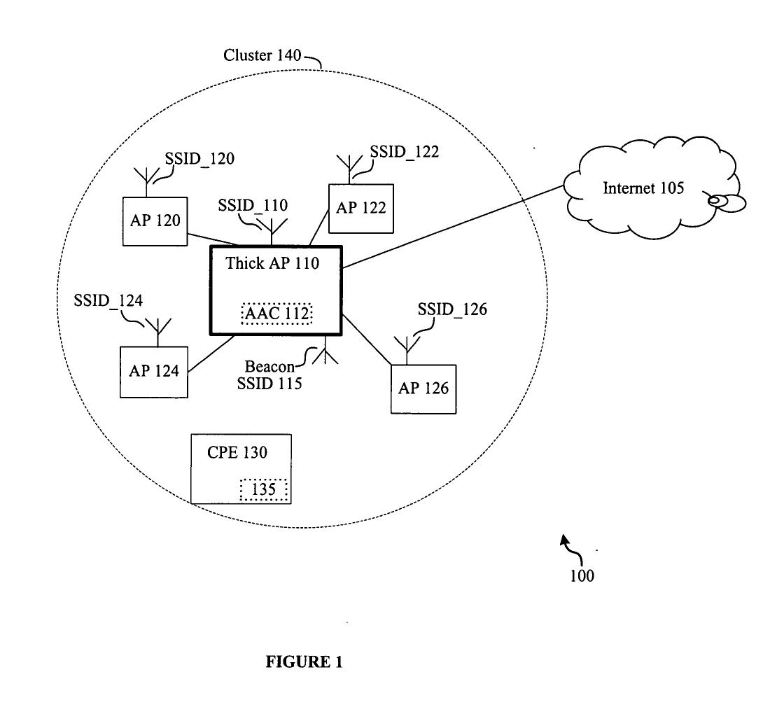

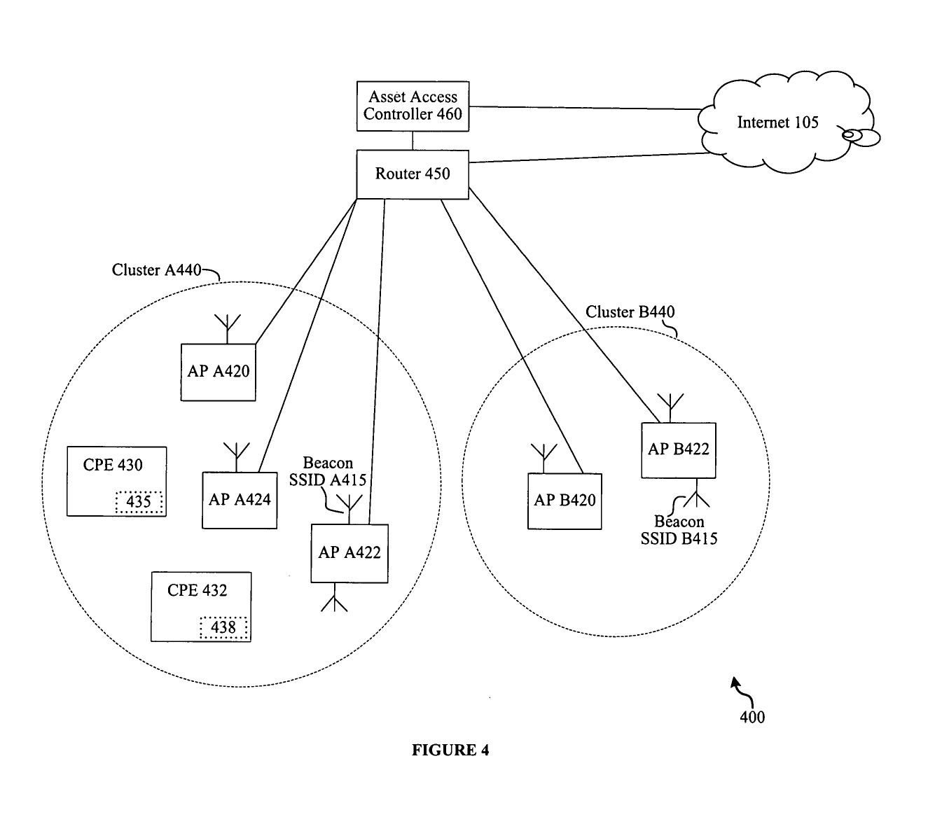

Asset Access Controller: The AAC incorporates the network management functionalities of both (1) determining whether a CPE is permitted to access the Internet (this process is also known as “access control” or “authentication”), and (2) determining which AP a CPE can connect to (this process is also known as “asset control”). The AAC can be part of a “Thick AP” (i.e., an ordinary AP with at least the added functionalities of an AAC) to control a “cluster” of APs (e.g., Thick AP 110 in FIG. 1), or the AAC can be a stand alone system to handle multiple clusters of APs (e.g., AAC 460 in FIG. 4). In another aspect, the AAC may be a, or part of a, network management device and/or computing system.

A “cluster” of APs is a group of APs whose wireless signal coverages substantially overlap. For example, in FIG. 1, the wireless signal coverages of Thick AP 110 and APs 120, 122, 124 and 126 substantially overlap, and they form Cluster 140. In another embodiment, a cluster may be a group of APs whose wireless signal coverages only partially overlap.

The AAC maintains information regarding (1) how many APs are in a cluster; (2) client loading for each AP; and (3) bandwidth loading for each AP. The AAC can pull or update information regarding the number of CPEs or bandwidth loading of an AP. Such information may be organized in an “asset list” or “asset table.” In another embodiment, the AAC may also maintain information related to the amount of data uploaded, amount of data downloaded, total connection time or other usage statistics associated with CPEs or users. In such an embodiment, the AAC can pull or receive such usage statistics from the APs.

When the AAC receives a request for access to the Internet from a Daemon on a CPE, the AAC will review its asset table to determine which APs have sufficient capacity to accept or support a new CPE connection, or in other words, sufficient capacity to not cause an imbalance in the client loading of Wi-Fi network nor an overloading in an AP. An AP with sufficient capacity to accept or support new CPE connections is referred to herein as an “available AP.” The AAC will then provide the Daemon with the SSID of an available AP to switch to, or a list of available APs to switch to. In another embodiment, the AAC may also review, search, access and/or process its asset table to determine which AP is loaded with the least number of clients or bandwidth (referred to herein as the “least loaded” AP). In such an embodiment, the AAC will then provide the Daemon with the SSID of the least loaded AP.

### EXAMPLE EMBODIMENTS OF THE PRESENT INVENTION

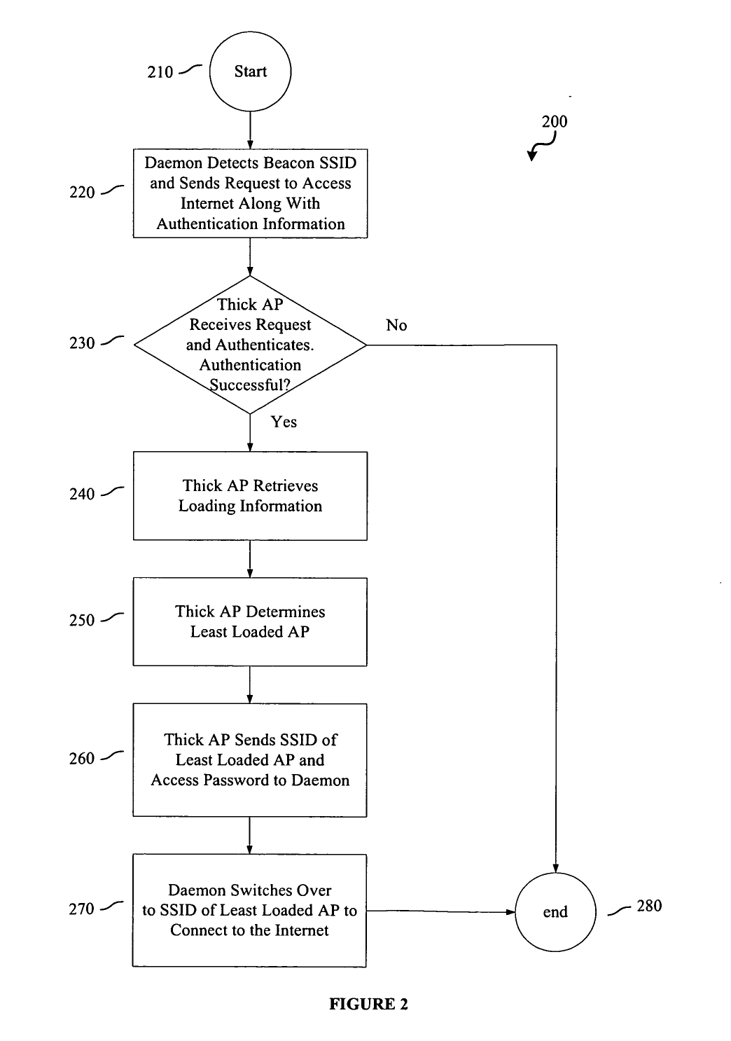

Embodiments of the present invention of System 100 will be further described with reference to FIGS. 1 and 2. As shown in FIG. 1, Thick AP 110 and APs 120, 122, 124 and 126 may be grouped in Cluster 140. APs 120, 122, 124 and 126 are also connected to Thick AP 110. In one embodiment, such a connection may be a wired Ethernet connection. In another embodiment, such a connection may be a wireless connection. Thick AP 110 maintains a list of IP addresses of the other APs in Cluster 140. Thick AP 110 has access to the number of clients or bandwidth of each AP in Cluster 140.

In one embodiment, Thick AP 110 may be the only device in Cluster 140 to provide DHCP and/or authentication services. In another embodiment, APs 120, 122, 124 and/or 126 may have Dynamic Host Configuration Protocol (DHCP) and/or authentication capabilities. In yet another embodiment APs 120, 122, 124 and 126 may communicate with, provide access to, or access Internet 105 via Thick AP 110. In yet another embodiment, APs 120, 122, 124 and 126 may directly communicate with, provide access to, or access Internet 105.

While FIG. 1 shows that AAC 112 is incorporated into Thick AP 110, one of ordinary skill in the art will understand that AAC 112 may be a stand alone system, and System 100 would operate in substantially the same manner.

Thick AP 110 operates Beacon SSID 115. In addition, each AP shown in FIG. 1 operates a unique SSID, according to the following table:

TABLE 1
Access Points of FIG. 1 and Unique SSIDs

| AP | SSID |
|---|---|
| AP 120 | SSID_120 |
| AP 122 | SSID_122 |
| AP 124 | SSID_124 |
| AP 126 | SSID_126 |
| Thick AP 110 | SSID_110 |

FIG. 2 illustrates Process 200 according to System 100 and FIG. 1. In particular, Process 200 shows the flow of operations in connecting CPE 130 to Internet 105 so that the APs in Cluster 140 are balanced. Process 200 begins at Step 210. At Step 220, Daemon 135 detects Beacon SSID 115 and Daemon 135 will connect to Beacon SSID 115 and send a request to connect to Internet 105 along with authentication information. At Step 230, Thick AP 110 receives the request and authentication information via Beacon SSID 115, and authenticates CPE 135 by determining whether CPE 135 has the necessary privileges to access Internet 105. If the authentication is not successful, Process 200 proceeds from Step 230 to Step 280 and ends. However, if the authentication is successful, Process 200 proceeds from Step 230 to Step 240.

At Step 240, Thick AP 110 will communicate with each AP in System 100 to retrieve client and/or bandwidth loading information for each AP. Next, at Step 250, Thick AP 110 will determine which AP in Cluster 140 is servicing the least number of CPEs based on the loading information received. By way of example, AP 122 may be the AP with the least number of CPEs connected to it.

Next, at Step 260, Thick AP 110 will then send to Daemon 135 via Beacon SSID 115 the SSID of AP 122 (i.e. SSID_122) and an access password. The access password may be fixed, in accordance with WEP or WPA, a one time password (“OTP”), a one time certificate (“OTC”) or blank. Next, at Step 270, Daemon 135 will instruct or operate the Wi-Fi driver or application on CPE 130 to switch over to SSID_122 and connect to the Internet using the access password. Process 200 then proceeds from Step 270 and ends at Step 280. In this manner, the network management functions of the Thick AP can facilitate the even or balanced distribution of the clients or bandwidth in System 100.

In another embodiment, Thick AP 110 may determine which AP in Cluster 140 is servicing the least amount of bandwidth, and send the SSID of that AP and an access password to Daemon 135.

In another embodiment, System 100 may be deployed in an enclosed area where the number of clients or bandwidth load is more than a single AP may effectively or efficiently handle. Multi-cluster setups can be used for different areas of the network.

In another embodiment, SSID_112 may be open (i.e., without Wi-Fi encryption); or encrypted using WEP or WPA, or employ other forms of wireless networking security. Where WEP, WPA or other form of security is used for SSID_112, the password associated with the WEP, WPA or other form of security may be different from the access password in Steps 260 and 270.

In another example, Thick AP 110 may be the AP that is least loaded in System 100. In such an example, at Step 260, Thick AP 110 will then send to Daemon 135 via Beacon SSID 115 SSID_110 and an access password. Then, at Step 270, Daemon 135 will instruct or operate the Wi-Fi driver or application on CPE 130 to switch over to SSID_110 and connect to the Internet using the access password. Process 200 then proceeds from Step 270 to Step 280 and ends.

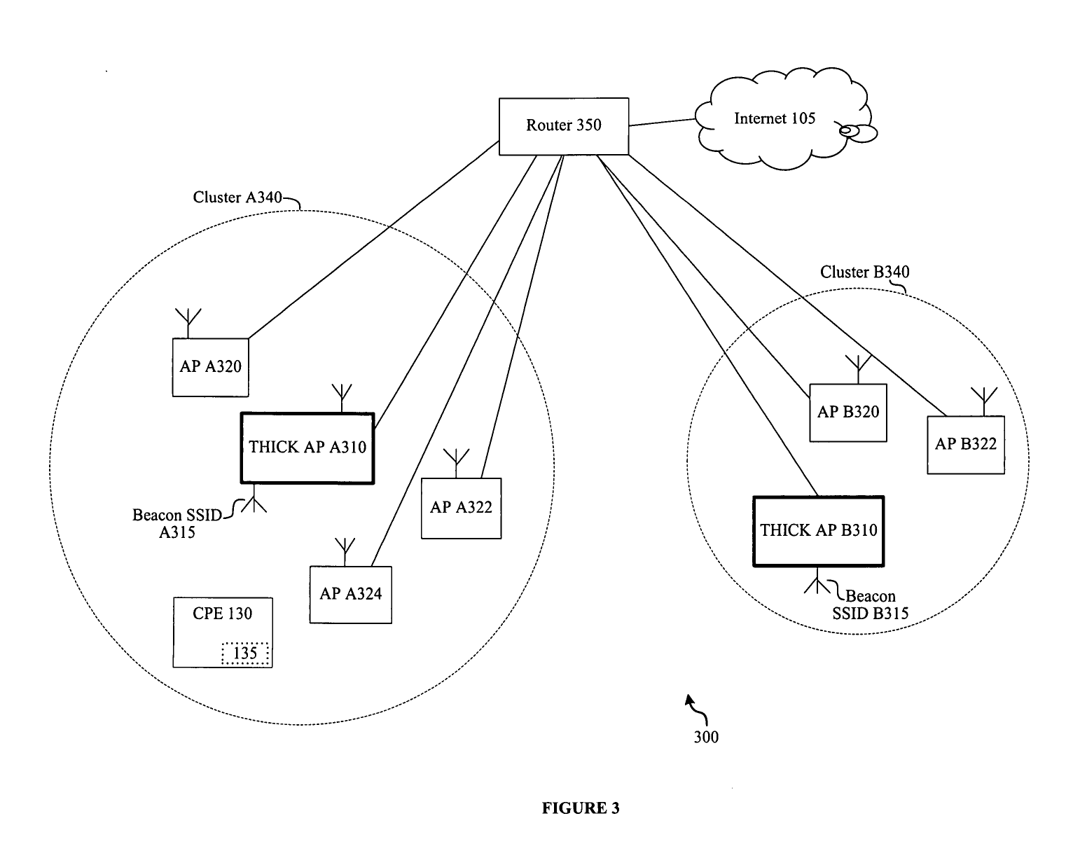

FIG. 3 shows System 300, which is another embodiment of the present invention where a Thick AP (e.g., Thick AP A310 or Thick AP B310) may be connected to the other APs in its cluster via a router (e.g., Router 350). As shown in FIG. 3, Thick AP A310 and APs A320, A322, A324 are in Cluster A340. Also, Thick AP B310 and APs B320 and B322 are in Cluster B340. Thick AP A310 operates Beacon SSID A315, and Thick AP B310 operates Beacon SSID B315. In one embodiment, Beacon SSIDs A315 and B315 are the same. In another embodiment, Beacon SSIDs A315 and B315 are different. Thick APs A310 and B310 each maintain a list of IP addresses of each AP in Clusters A340 and B340, respectively. Each AP, including each Thick AP, is connected to Router 350, which is in turn connected to Internet 105. Router 350 may have DHCP functionalities and/or wide area network (WAN) connection to the Internet via an Internet service provider. In another embodiment, Router 350 may be a network switch].

In FIG. 3, when CPE 130 is within Cluster A340, Daemon 135 detects Beacon SSID A315. Daemon 135 will proceed to connect to Beacon SSID A315 to communicate with the Thick AP A310 and then authenticate itself in order to establish a connection to Internet 105.

Once CPE 130 is authenticated, Thick AP A310 will communicate with each AP in Cluster A340 to retrieve client and/or bandwidth loading information for each AP in Cluster A340. This communication may be via Router 350. Based on the information received, Thick AP A310 will determine which AP in Cluster A340 is servicing the least number of CPEs. By way of example, AP A322 is the AP with the least number of CPEs connected to it.

Thick AP A310 will then send to Daemon 135 the SSID of AP A322 (e.g. SSID_322) and an access password. Daemon 135 will then instruct or operate the Wi-Fi driver or application on CPE 130 to switch over to SSID_322 and connect to the Internet using the access password. In this manner, the network management functions of Thick AP A310 can facilitate the even or balanced distribution of the clients or bandwidth in Cluster A340 of System 300.

FIG. 4 shows System 400, which is yet another embodiment of the present invention where all APs may be ordinary APs and do not necessarily have asset control functionalities. In such an embodiment, each AP may operate two SSIDs: (a) an SSID which is unique to each AP, and (2) an SSID that is a Beacon SSID. As shown in FIG. 4, APs A420, A422 and A424 are in Cluster A440. Also, APs B420 and B422 are in Cluster B440. AP A422 operates Beacon SSID A415, and AP B422 operates Beacon SSID B415. In one embodiment, Beacon SSIDs A415 and B415 are the same. In another embodiment, Beacon SSIDs A415 and B415 are different.

Each AP is connected to Router 450, which is in turn connected to Internet 105. In another embodiment, Router 450 may be a switch. AAC 460 is connected to both Router 450 and Internet 105. AAC 460 maintains information regarding Clusters A440 and B440, as well as the APs within each cluster. AAC 460 also maintains client and/or bandwidth loading information for each AP in System 400. Such information may be obtained or updated using a pull method, whereby AAC 460 checks or requests the client or bandwidth loading information for each AP on an ad hoc or periodic basis. Such information may also be obtained or updated using a push method where each AP sends its client or bandwidth loading information at a fixed interval. Communications between AAC 460 and the APs in System 400 may be via Router 450.

When CPE 430 is within Cluster A440, Daemon 435 detects Beacon SSID A415 operated by AP A422. Daemon 435 then connects to Beacon SSID A415 to communicate with AP A422, and then authenticate itself. Once CPE 430 is authenticated, and because the request was forwarded by an AP in Cluster A440, AAC 460 will communicate with each AP in Cluster A440 to retrieve client and/or bandwidth loading information of each AP in Cluster A440. Based on the loading information received, AAC 460 will determine which AP in Cluster A440 is servicing the least number of CPEs. AAC 460 will then send to Daemon 435 the SSID of the least loaded AP and an access password. Daemon 435 will then instruct or operate the Wi-Fi driver or application on CPE 430 to switch over to the SSID of the least loaded AP and connect to the Internet using the access password. In this manner, the network management functions of AAC 460 can facilitate the even or balanced distribution of the clients or bandwidth in System 400.

### Example 1 of System 400

In this example, the loading and bandwidth information of the APs in System 400 are as follows:

TABLE 2
Access Points Loading for Example 1 of System 400

| | | | Bandwidth |
|---|---|---|---|
| Access Point | SSID | # of CPEs | (Mbps) |
| AP A420 | SSID_A420 | 3 | 3 |
| AP A422 | SSID_A422 | 4 | 7 |
| AP A424 | SSID_A424 | 4 | 2 |

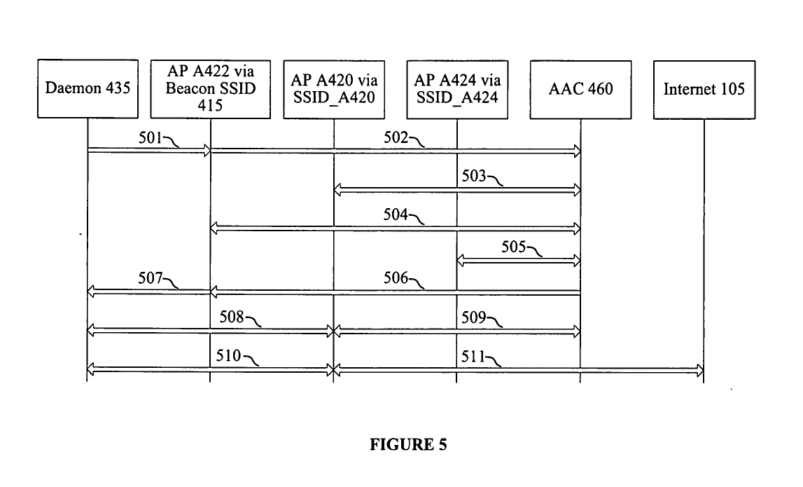

Reference will now be made for FIGS. 4 and 5 in showing operations of System 400 and the communications between the devices and elements in System 400. When Daemon 435 of CPE 430 detects Beacon SSID A415, Daemon 435 will connect to Beacon SSID A415 operated by AP 422 and then provide authenticate information in order to establish a connection to Internet 105 (Data Transmission 501). AP A422 will forward CPE 430's request to access Internet 105 and authentication information to AAC 460 (Data Transmission 502). Once CPE 430 has been authenticated, AAC 460 will communicate with each AP in Cluster A440 to retrieve client and/or bandwidth loading information of each AP in Cluster A440 (Data Transmissions 503, 504 and 505). Here, AAC 460 may obtain the information shown in Table 2, and determine which AP is servicing the least number of CPEs. Table 2 shows that AP A420 is servicing the least number of CPEs.

AAC 460 will then send SSID_A420 information and an access password to Daemon 435 via Beacon SSID 415 (Data Transmissions 506 and 507). Daemon 435 will then instruct or operate the Wi-Fi driver or application on CPE 430 to switch over to SSID_A420, thereby establishing a Wi-Fi connection with AP A420 via SSID_A420 (Data Transmission 508). Daemon 435 will then authenticate with AAC 460 using the access password provided by AAC 460 (Data Transmissions 508 and 509), and AAC 460 may notify Daemon 435 that CPE 430 is authorized to access Internet 105 (Data Transmissions 508 and 509). CPE 430 will then be able to access Internet 105 over AP A420 (Data Transmissions 510 and 511). Thus, the client loading of System 400 will be balanced.

### Example 2 of System 400

In this Example 2, the loading and bandwidth information of the APs in System 400 are as follows:

TABLE 3
Access Points Loading for Example 2 of System 400

| | | | Bandwidth |
|---|---|---|---|
| Access Point | SSID | # of CPEs | (Mbps) |
| AP A420 | SSID_A420 | 4 | 6 |
| AP A422 | SSID_A422 | 4 | 7 |
| AP A424 | SSID_A424 | 4 | 2 |

When Daemon 438 of CPE 432 detects Beacon SSID A415, Daemon 438 will connect to Beacon SSID A415 to communicate with AP A422, and then authenticate itself. Once CPE 432 has been authenticated, AAC 460 will communicate with each AP in Cluster A440 to retrieve client and/or bandwidth loading information of each AP in Cluster A440. Here, it will obtain the information shown in Table 3, and determine which AP is servicing the least number of CPEs. In this case, the system is evenly balanced in terms of client loading, and AAC 460 may send the SSID of any of the AP to Daemon 438 for CPE 432 to connect to.

Bandwidth Balancing

In another embodiment, in selecting which AP for CPE 432 to connect to, AAC 460 may further determine which AP is servicing the least amount of bandwidth. For example, with reference to FIG. 4, if the least loaded AP in terms of bandwidth is AP A424, AAC 460 will send SSID_A424 and an access password to Daemon 438. Daemon 438 will then instruct or operate the Wi-Fi driver or application on CPE 430 to switch over to SSID_A424 and connect to the Internet using the access password. Thus, the bandwidth loading in System 400 will be balanced.

In yet another embodiment, in determining which AP is least loaded, AAC 460 may prioritize bandwidth loading over CPE loading. Thus, in such an embodiment, in Example 1 of System 400, AAC 460 would determine that AP A424—with a bandwidth loading of 2 Mpbs as shown in Table 2—is the least loaded AP. Thus, AAC 460 would send SSID_A424 and a password to Daemon 435 in Data Transmissions 506 and 507.

One or ordinary skill in the art will appreciate that Internet 105 or the Internet in any of the embodiments described herein may be replaced with any computing network, intranet etc. In such an instance, the embodiments will operate in substantially the same manner.

Any of the embodiments described herein may also use authentication techniques and protocols described in U.S. patent application Ser. No. 13/068,395.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer networking system for load balancing, comprising:
a first computing device;
one or more first access points, wherein each of the one or more first access points has a service set identifier; and
a network management device having at least one memory with at least one region for storing executable program code, and at least one processor for executing the program code stored in the memory, wherein the program code, when executed:
a) receives a request from the first computing device to access a network, wherein the request is received via a signal associated with a first service set identifier;
b) receives loading information, wherein the loading information includes information associated with at least one of the one or more first access points;
c) determines, from the loading information, a least loaded access point, wherein the least loaded access point is one of the one or more first access points that is associated with a smallest quantity of one or more second computing devices; and
d) sends a service set identifier associated with the least loaded access point.

2. The computer networking system of claim 1, wherein the network management device is an access point.

3. The computer networking system of claim 1, wherein the network management device is one of the one or more first access points.

4. The computer networking system of claim 1, wherein the network management device is a computing system.

5. The computer networking system of claim 1, wherein the service set identifier associated with the least loaded access point is sent via the signal associated with first service set identifier.

6. The computer networking system of claim 1, wherein the service set identifier associated with the least loaded access point is sent to the first computing device.

7. The computer networking system of claim 6, wherein the first computing device further comprises a daemon or software application, and wherein communications between the first computing device and the network management device are sent and received via the daemon or software application.

8. The computer networking system of claim 7, wherein the daemon or software application detects the first service set identifier and the service set identifiers of the one or more first access points.

9. The computer networking system of claim 1, wherein each of the first access points has a unique service set identifier.

10. The computer networking system of claim 1, wherein the first service set identifier is different from a service set identifier of each of the first access points.

11. The computer networking system of claim 1, wherein the loading information is received from a first access point associated with the loading information.

12. The computer networking system of claim 1, wherein the loading information includes information associated with a second computing device.

13. The computer networking system of claim 1, wherein the loading information includes information associated with a second computing device associated with a first access point.

14. The computer networking system of claim 1, wherein the loading information includes resource status information associated with a first access point.

15. The computer networking system of claim 1, wherein the loading information includes a quantity of the second computing devices associated with a first access point.

16. The computer networking system of claim 1, wherein the request to access the network, the loading information, and the service set identifiers of the first access points are sent or received by the network management device via a router or switch.

17. The computer networking system of claim 1, wherein the network is the Internet, the World Wide Web, or an intranet.

18. The computer networking system of claim 1, wherein the network management device is directly connected to the network.

19. The computer networking system of claim 1, wherein the network management device is indirectly connected to the network.

20. The computer networking system of claim 1, wherein the program code, when executed, further:
receives an access profile from the first computing device; and
determines whether the first computing device is permitted to access the network.

21. The computer networking system of claim 1, wherein the program code, when executed, further:
receives bandwidth information associated with a first access point;
determines, from the bandwidth information, a least bandwidth access point, wherein the least bandwidth access point is one of the first access points associated with a smallest quantity of bandwidth; and
sends a service set identifier associated with the least bandwidth access point.

22. The computer networking infrastructure of claim 1, wherein the program code,
when executed, further:
generates a token, one time password or one time certificate, and
sends the token, one time password or one time certificate to the first computing device; and
the first computing device is configured to access the network through one of the first access points using the token, one time password or one time certificate.

23. The computer networking infrastructure of claim 22, wherein the one of the first access points is the least loaded access point.

24. The computer networking infrastructure of claim 1, wherein the service set identifiers of at least one of the first access points are hidden or not broadcasted.

25. A method for load balancing a computer networking system, comprising:
a) receiving, by a network management device, a request from a first computing device to access a network, wherein the request is received via a signal associated with a first service set identifier, and wherein the network management device having at least one memory with at least one region for storing executable program code and at least one processor for executing the program code stored in the memory;
b) receiving, by the network management device, loading information, wherein the loading information includes information associated with at least one of one or more first access points, and wherein each of the one or more first access points has a service set identifier;
c) determining, by the network management device, from the loading information, a least loaded access point, wherein the least loaded access point is one of the one or more first access points that is associated with a smallest quantity of one or more second computing devices; and
d) sending, by the network management device, a service set identifier associated with the least loaded access point.

26. The method of claim 25, wherein the network management device is an access point.

27. The method of claim 25, wherein the network management device is one of the one or more first access points.

28. The method of claim 25, wherein the network management device is a computing system.

29. The method of claim 25, wherein the service set identifier associated with the least loaded access point is sent via the signal associated with first service set identifier.

30. The method of claim 25, wherein the service set identifier associated with the least loaded access point is sent to the first computing device.

31. The method of claim 30, wherein the first computing device further comprises a daemon or software application, and wherein communications between the first computing device and the network management device are sent and received via the daemon or software application.

32. The method of claim 31, wherein the daemon or software application detects the first service set identifier and the service set identifiers of the one or more first access points.

33. The method of claim 25, wherein each of the first access points has a unique service set identifier.

34. The method of claim 25, wherein the first service set identifier is different from a service set identifier of each of the first access points.

35. The method of claim 25, wherein the loading information is received from a first access point associated with the loading information.

36. The method of claim 25, wherein the loading information includes information associated with a second computing device.

37. The method of claim 25, wherein the loading information includes information associated with a second computing device associated with a first access point.

38. The method of claim 25, wherein the loading information includes resource status information associated with a first access point.

39. The method of claim 25, wherein the loading information includes a quantity of the second computing devices associated with a first access point.

40. The method of claim 25, wherein the request to access the network, the loading information, and the service set identifiers of the first access points are sent or received by the network management device via a router or switch.

41. The method of claim 25, wherein the network is the Internet, the World Wide Web, or an intranet.

42. The method of claim 25, wherein the network management device is directly connected to the network.

43. The method of claim 25, wherein the network management device is indirectly connected to the network.

44. The method of claim 25, wherein the method further comprises:
receiving, by the network management device, an access profile from the first computing device; and
determining, by the network management device, whether the first computing device is permitted to access the network.

45. The method of claim 25, wherein the method further comprises:
receiving, by the network management device, bandwidth information associated with a first access point;
determining, by the network management device, from the bandwidth information, a least bandwidth access point, wherein the least bandwidth access point is one of the first access points associated with a smallest quantity of bandwidth; and
sending, by the network management device, a service set identifier associated with the least bandwidth access point.

46. The method of claim 25, wherein
the method further comprises:
generating, by the network management device, a token, one time password or one time certificate, and
sending, by the network management device, the token, one time password or one time certificate to the first computing device; and
the first computing device is configured to access the network through one of the first access points using the token, one time password or one time certificate.

47. The method of claim 46, wherein the one of the first access points is the least loaded access point.

48. The method of claim 25, wherein the service set identifiers of at least one of the first access points are hidden or not broadcasted.

49. A computer networking system for load balancing, comprising:
a first computing device;
one or more first access points, wherein each of the one or more first access points has a service set identifier;
a network management device having at least one memory with at least one region for storing executable program code, and at least one processor for executing the program code stored in the memory, wherein the program code, when executed:
a) receives a request from the first computing device to access a network, wherein the request is received via a signal associated with a first service set identifier;
b) receives loading information, wherein the loading information includes information associated with at least one of the one or more first access points;
c) generates, from the information received, a list comprising at least one of the one or more first access points able to support a connection with the first computing device; and
d) sends the list to the first computing device.

50. The computer networking system of claim 49, wherein the network management device is an access point.

51. The computer networking system of claim 49, wherein the network management device is one of the one or more first access points.

52. The computer networking system of claim 49, wherein the network management device is a computing system.

53. The computer networking system of claim 49, wherein list is sent via the signal associated with first service set identifier.

54. The computer networking system of claim 49, wherein list is sent to the first computing device.

55. The computer networking system of claim 54, wherein the first computing device further comprises a daemon or software application, and wherein communications between the first computing device and the network management device are sent and received via the daemon or software application.

56. The computer networking system of claim 55, wherein the daemon or software application detects the first service set identifier and the service set identifiers of the one or more first access points.

57. The computer networking system of claim 49, wherein each of the first access points has a unique service set identifier.

58. The computer networking system of claim 49, wherein the first service set identifier is different from a service set identifier of each of the first access points.

59. The computer networking system of claim 49, wherein the loading information is received from a first access point associated with the loading information.

60. The computer networking system of claim 49, wherein the loading information includes information associated with a second computing device.

61. The computer networking system of claim 49, wherein the loading information includes information associated with a second computing device associated with a first access point.

62. The computer networking system of claim 49, wherein the loading information includes resource status information associated with a first access point.

63. The computer networking system of claim 49, wherein the loading information includes a quantity of the second computing devices associated with a first access point.

64. The computer networking system of claim 49, wherein the request to access the network, the loading information, and the service set identifiers of the first access points are sent or received by the network management device via a router or switch.

65. The computer networking system of claim 49, wherein the network is the Internet, the World Wide Web, or an intranet.

66. The computer networking system of claim 49, wherein the network management device is directly connected to the network.

67. The computer networking system of claim 49, wherein the network management device is indirectly connected to the network.

68. The computer networking system of claim 49, wherein the program code, when executed, further:
receives an access profile from the first computing device; and determines whether the first computing device is permitted to access the network.

69. The computer networking infrastructure of claim 49, wherein the program code,
when executed, further:
generates a token, one time password or one time certificate, and
sends the token, one time password or one time certificate to the first computing device; and
the first computing device is configured to access the network through one of the first access points using the token, one time password or one time certificate.

70. The computer networking infrastructure of claim 49, wherein the service set identifiers of at least one of the first access points are hidden or not broadcasted.

71. A method for load balancing a computer networking system, comprising:
a) receiving, by a network management device, a request from a first computing device to access a network, wherein the request is received via a signal associated with a first service set identifier, and wherein the network management device having at least one memory with at least one region for storing executable program code and at least one processor for executing the program code stored in the memory;
b) receiving, by the network management device, loading information, wherein the loading information includes information associated with at least one of the one or more first access points, and wherein each of the one or more first access points has a service set identifier;
c) generating, by the network management device, from the information received, a list comprising at least one of the one or more first access points able to support a connection with the first computing device; and
d) sending, by the network management device, the list to the first computing device.

72. The method of claim 71, wherein the network management device is an access point.

73. The method of claim 71, wherein the network management device is one of the one or more first access points.

74. The method of claim 71, wherein the network management device is a computing system.

75. The method of claim 71, wherein the list is sent via the signal associated with first service set identifier.

76. The method of claim 71, wherein the list
is sent to the first computing device.

77. The method of claim 76, wherein the first computing device further comprises a daemon or software application, and wherein communications between the first computing device and the network management device are sent and received via the daemon or software application.

78. The method of claim 77, wherein the daemon or software application detects the first service set identifier and the service set identifiers of the one or more first access points.

79. The method of claim 71, wherein each of the first access points has a unique service set identifier.

80. The method of claim 71, wherein the first service set identifier is different from a service set identifier of each of the first access points.

81. The method of claim 71, wherein the loading information is received from a first access point associated with the loading information.

82. The method of claim 71, wherein the loading information includes information associated with a second computing device.

83. The method of claim 71, wherein the loading information includes information associated with a second computing device associated with a first access point.

84. The method of claim 71, wherein the loading information includes resource status information associated with a first access point.

85. The method of claim 71, wherein the loading information includes a quantity of the second computing devices associated with a first access point.

86. The method of claim 71, wherein the request to access the network, the loading information, and the service set identifiers of the first access points are sent or received by the network management device via a router or switch.

87. The method of claim 71, wherein the network is the Internet, the World Wide Web, or an intranet.

88. The method of claim 71, wherein the network management device is directly connected to the network.

89. The method of claim 71, wherein the network management device is indirectly connected to the network.

90. The method of claim 71, wherein the method further comprises:
receiving, by the network management device, an access profile from the first computing device; and determining, by the network management device, whether the first computing device is permitted to access the network.

91. The method of claim 71, wherein
the method further comprises:
generating, by the network management device, a token, one time password or one time certificate, and
sending, by the network management device, the token, one time password or one time certificate to the first computing device; and
the first computing device is configured to access the network through one of the first access points using the token, one time password or one time certificate.

92. The method of claim 71, wherein the service set identifiers of at least one of the first access points are hidden or not broadcasted.

93. A system for load balancing a computer networking system, comprising:
a) at least one memory having at least one region for storing executable program code;
b) at least one processor for executing the program code stored in the memory;
c) means for receiving a request from a first computing device to access a network, wherein the request is received via a signal associated with a first service set identifier;
d) means for receiving loading information, wherein the loading information includes information associated with at least one of one or more first access points, and wherein each of the one or more first access points has a service set identifier;
e) means for determining, from the loading information, a least loaded access point, wherein the least loaded access point is one of the one or more first access points that is associated with a smallest quantity of one or more second computing devices; and
f) means for sending a service set identifier associated with the least loaded access point.
